(19) United States
(12) Patent Application Publication
(10) Pub. No.: US 2026/0247504 A1
(43) Pub. Date: Aug. 20, 2026

(54) HEATING DEVICE, CONTROL METHOD FOR HEATING DEVICE, AND PROGRAM

(71) Applicant: Panasonic Intellectual Property Management Co., Ltd., Osaka (JP)

(72) Inventors: Tadashi NITTA, Kyoto (JP); Nobuhiro OGAWA, Nara (JP); Yuji SHIRAKAWA, Osaka (JP); Shiro NAKATOMI, Kyoto (JP); Masaharu TSUJIMOTO, Nara (JP); Michiyo OZONO, Kanagawa (JP); Rina TANIGUCHI, Osaka (JP)

(21) Appl. No.: 19/473,355

(22) PCT Filed: Jun. 4, 2024
(86) PCT No.: PCT/JP2024/020344

§ 371 Date: Oct. 7, 2025

(30) Foreign Application Priority Data
Jun. 28, 2023 (JP) 2023-105735

(51) Int. Cl. H05B 6/68; H05B 6/64

(52) U.S. Cl. CPC H05B 6/687; H05B 6/6435

(57) ABSTRACT

The present disclosure provides a heating device, a control method for a heating device, and a program capable of improving a user's convenience regarding heating and cooking.

A heating device according to the present disclosure is a heating device that heats an object to be heated with a heating unit, the device including: a heating unit capable of outputting microwaves at a plurality of different outputs; a manipulation unit that receives input of a heating condition including a heating time and an output of the heating unit; and a control unit that operates the heating unit based on the heating condition, wherein the manipulation unit includes a high-output manipulation unit that provides an instruction for a high-output heating including operating the heating unit at an output higher than the heating condition.

### TECHNICAL FIELD

The present disclosure relates to a heating device, a control method for a heating device, and a program.

### BACKGROUND ART

Patent Literature 1 discloses a technique for shortening time required for heating and cooking in a heating device that executes high-frequency heating and cooking based on a heating condition input by a user.

### CITATION LIST

### Patent Literature

Patent Literature 1: Japanese Patent Laid-Open No. 2014-122715

### SUMMARY OF INVENTION

### Technical Problem

The present disclosure provides a heating device, a control method for a heating device, and a program capable of improving a user's convenience regarding heating and cooking.

### Solution to Problem

A heating device according to the present disclosure is a heating device that heats an object to be heated with a heating unit, the device including: a heating unit capable of outputting microwaves at a plurality of different outputs; a manipulation unit that receives input of a heating condition including a heating time and an output of the heating unit; and a control unit that operates the heating unit based on the heating condition, wherein the manipulation unit includes a high-output manipulation unit that provides an instruction for a high-output heating including operating the heating unit at an output higher than the heating condition, and the high-output manipulation unit receives an instruction for the high-output heating including operating the heating unit at a maximum output of the heating unit.

A heating device according to the present disclosure is a heating device that heats an object to be heated with a heating unit, the device including: a heating unit capable of outputting microwaves at a plurality of different outputs; a manipulation unit that receives input of a heating condition including a heating time and an output of the heating unit; and a control unit that operates the heating unit based on the heating condition, wherein the manipulation unit includes a high-output manipulation unit that provides an instruction for a high-output heating including operating the heating unit at an output higher than the heating condition, and the control unit acquires an output possible time for which the heating unit can output microwaves at a higher output than the heating condition, and the control unit determines a heating time and an output of the heating unit in the high-output heating such that a time for which the heating unit is operated at an output higher than the heating condition does not exceed the output possible time and such that a heating amount in the high-output heating is a heating amount corresponding to the heating condition.

A heating device according to the present disclosure is a heating device that heats an object to be heated with a heating unit, the device including: a heating unit capable of outputting microwaves at a plurality of different outputs; a manipulation unit that receives input of a heating condition including a heating time and an output of the heating unit; and a control unit that operates the heating unit based on the heating condition, wherein the control unit executes a high-output heating including operating the heating unit at a maximum output higher than the heating condition.

A heating device according to the present disclosure is a heating device including: a heating unit that is configured to be capable of outputting microwaves at a plurality of different outputs and heats an object to be heated; a manipulation unit that receives input of a heating condition including a heating time and an output of the heating unit; and a control unit that operates the heating unit based on the heating condition, the control unit executing a high-output heating including operating the heating unit at an output higher than the heating condition, wherein the control unit acquires an output possible time for which the heating unit can output microwaves at a higher output than the heating condition, and the control unit determines a heating time and an output of the heating unit in the high-output heating such that a time for which the heating unit is operated at an output higher than the heating condition does not exceed the output possible time and such that a heating amount in the high-output heating is a heating amount corresponding to the heating condition.

A control method for a heating device according to the present disclosure is a control method for a heating device including a heating unit and a manipulation unit, the heating unit being capable of outputting microwaves at a plurality of different outputs, the manipulation unit receiving input of a heating condition, the heating condition including a heating time and an output of the heating unit, the method including: using a control unit that controls the heating unit to operate the heating unit based on the heating condition, and execute a high-output heating including operating the heating unit at a maximum output higher than the heating condition in response to a manipulation of a high-output manipulation unit included in the manipulation unit.

A control method for a heating device according to the present disclosure is a control method for a heating device including a heating unit and a manipulation unit, the heating unit being capable of outputting microwaves at a plurality of different outputs, the manipulation unit receiving input of a heating condition, the heating condition including a heating time and an output of the heating unit, the method including: using a control unit that controls the heating unit to operate the heating unit based on the heating condition, and execute a high-output heating including operating the heating unit at a maximum output higher than the heating condition in response to a manipulation of a high-output manipulation unit included in the manipulation unit, wherein the control unit acquires an output possible time for which the heating unit can output microwaves at a higher output than the heating condition, and the control unit determines a heating time and an output of the heating unit in the high-output heating such that a time for which the heating unit is operated at an output higher than the heating condition does not exceed the output possible time and such that a heating amount in the high-output heating is a heating amount corresponding to the heating condition.

A program according to the present disclosure is a program causing a computer to function as a control unit, the computer controlling a heating device, the heating device including a heating unit and a manipulation unit, the heating unit being capable of outputting microwaves at a plurality of different outputs, the manipulation unit receiving input of a heating condition, the heating condition including a heating time and an output of the heating unit, the control unit operating the heating unit based on the heating condition, the control unit executing a high-output heating including operating the heating unit at a maximum output higher than the heating condition in response to a manipulation of a high-output manipulation unit included in the manipulation unit.

Note that this description includes all the contents of Japanese Patent Application No. 2023-105735, filed on Jun. 28, 2023.

### Advantageous Effects of Invention

The heating device, the control method for the heating device, and the program according to the present disclosure make it possible, through a simple manipulation, to provide an instruction for an operation to heat an object to be heated at an output higher than an output specified by the user. This improves the user's convenience regarding heating and cooking.

### BRIEF DESCRIPTION OF DRAWINGS

FIG. 1 is a perspective view of a heating device in Embodiment 1,

FIG. 2 is a front view of a manipulation panel in Embodiment 1.

FIG. 3 is a block diagram of the heating device in Embodiment 1,

FIG. 4 is a flowchart showing an example of operation of the heating device in Embodiment 1.

FIG. 5 is a flowchart showing an example of operation of the heating device in Embodiment 1.

FIG. 6 is a flowchart showing an example of operation of the heating device in Embodiment 1.

FIG. 7 is an explanatory diagram showing an example of display transition of the heating device in Embodiment 1.

FIG. 8 is a flowchart showing an example of operation of a heating device in Embodiment 2.

### DESCRIPTION OF EMBODIMENTS

(Knowledge Etc. On which the Present Disclosure is Based)

At the time when the inventors came up with the present disclosure, cooking devices used a technique to perform heating at a higher output than a heating condition input by a user, thereby heating an object to be heated in a shorter time. However, the conventional technique requires a manipulation such as switching between heating in accordance with the heating condition and using a higher output than the heating condition. The inventors have found a problem in which there is a need to simplify manipulation, and came to constitute the subject matter of the present disclosure to solve the problem.

The present disclosure now provides a heating device, a control method for a heating device, and a program capable of improving the user's convenience regarding heating and cooking.

Hereinafter, an embodiment is described in detail with reference to the drawings. However, more detailed description than necessary may be omitted. For example, detailed description may be omitted for already well-known matters, or duplicate description may be omitted for substantially the same configurations.

The accompanying drawings and the following description are provided to enable those skilled in the art to fully understand the present disclosure, and are not intended to limit the subject matter described in the claims.

### Embodiment 1

### 1-1. Configuration

### 1-1-1. Configuration of Heating Device

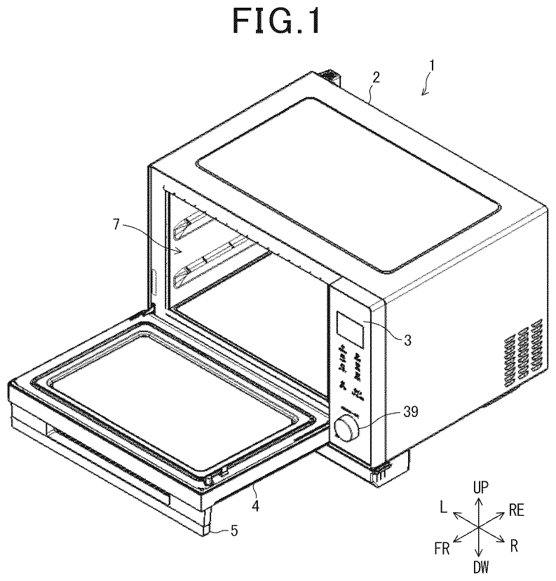

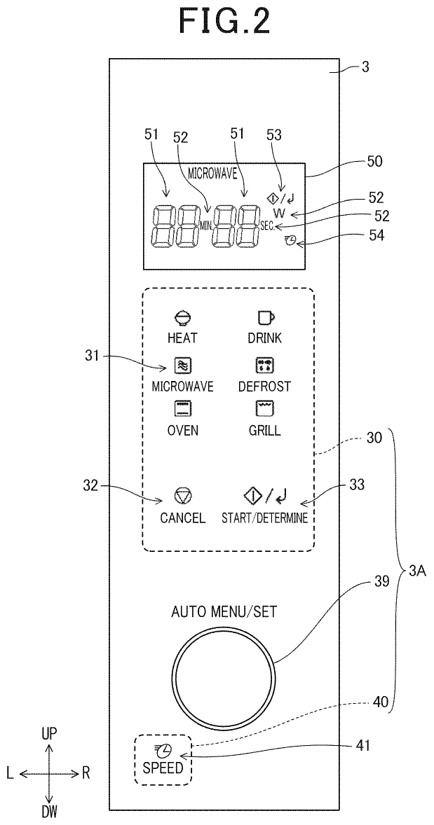

FIG. 1 is a perspective view of a heating device 1 according to Embodiment 1. The heating device 1 shown in FIG. 1 has a box-shaped cabinet 2. In FIG. 1 and FIG. 2 described below, directions corresponding to the cabinet 2 in the installed state of the heating device 1 is indicated by arrows. Reference character UP denotes the upper side, reference character DW denotes the lower side, reference character FR denotes the front side, reference character RE denotes the rear side, reference character R denotes the right direction, and reference character L denotes the left direction.

A door 4 is provided on the front surface of the cabinet 2 so as to be able to open and close. When the door 4 is opened, a heating chamber 7 provided inside the cabinet 2 is exposed. The heating chamber 7 accommodates an object to be heated by the heating device 1. The heating device 1 is a cooking appliance that heats and cooks an object to be heated, which is accommodated in a heating chamber 7, by irradiating the object with microwaves. The object to be heated in this embodiment is food.

A manipulation panel 3 is disposed on the front surface of the cabinet 2 so as to be aligned with the door 4. The manipulation panel 3 may be disposed on the front surface of the door 4. The manipulation panel 3 includes switches and the like that receive manipulations from a user, as described below.

The heating device 1 heats an object to be heated that is accommodated in the heating chamber 7 by a microwave function that uses microwaves. The heating device 1 described in this embodiment has an oven function and a grill function for heating an object to be heated using a graphite heater or the like, but these functions are not essential to the configuration of the present disclosure,

### [1-1-2. Configuration of Manipulation Unit]

FIG. 2 is a front view of a manipulation panel 3 in Embodiment 1.

The manipulation panel 3 includes a first manipulation unit 30, a dial 39, and a second manipulation unit 40. The first manipulation unit 30, the dial 39, and the second manipulation unit 40 constitute a manipulation unit 3A.

The first manipulation unit 30 includes a plurality of key manipulation units including a microwave heating instruction key 31, a cancel key 32, and a start key 33. The second manipulation unit 40 includes a short-time heating key 41 as a key manipulation unit. These key manipulation units are manipulation makers as target objects to be manipulated by a user, and receive at least any of the user's touch manipulation and pressing manipulation.

The microwave heating instruction key 31, the cancel key 32, and the start key 33 may be switches attached to the surface of the manipulation panel 3, or may be switches embedded on the back side of a flexible surface panel that constitutes the surface of the manipulation panel 3. The microwave heating instruction key 31, the cancel key 32, and the start key 33 may be provided on the surface panel of the manipulation panel 3 and composed of one or a plurality of contact sensors that detect the user's touch manipulation. Specifically, the microwave heating instruction key 31, the cancel key 32, and the start key 33 may each be associated with a manipulation position of the touch manipulation detected by the contact sensor.

The microwave heating instruction key 31 is a key manipulation unit that provides an instruction for the selection of the microwave function from among a plurality of functions, such as a microwave function, an oven function, and a grill function, provided in the heating device 1. The cancel key 32 is a key manipulation unit that provides an instruction for cancellation of an instruction provided by the manipulation of the microwave heating instruction key 31, the start key 33, and the dial 39. The start key 33 is a key manipulation unit that provides an instruction for a determination of an instruction provided by the manipulation of the microwave heating instruction key 31 and the dial 39, and provides an instruction for an operation in accordance with what is determined.

The heating device 1 is capable of switching between a plurality of outputs in the microwave function. The outputs of the heating device 1 are, for example, a microwave output values, and in this embodiment, an example is given in which the output can be switched between six levels of 150 watts (W), 300 W, 500 W, 600 W, 800 W, and 1000 W. These six levels of output are the outputs of a heating unit 60, which is described below, and may be configured to restrict the outputs that can be switched by the user's manipulation. This is just an example, and there is no restriction to the outputs of the heating device 1 to which the present disclosure is applied.

The first manipulation of the microwave heating instruction key 31 is an instruction to select the microwave function. Manipulation of the microwave heating instruction key 31 within a predetermined time from the first manipulation of the microwave heating instruction key 31 is a manipulation to provide an instruction for switching of the output of the microwave function. For example, in response to the first manipulation of the microwave heating instruction key 31, the initial value of 600 W is selected as the output of the microwave function of the heating device 1. Manipulation of the microwave heating instruction key 31 from the second time onwards is a manipulation to provide an instruction for switching of the output of the microwave function of the heating device 1 in sequence. In this embodiment, the output switching order is, for example, 600 W-500 W-300 W-150 W-800 W-600 W, and for any further manipulations, the output is switched in a cyclical manner in the above order. Of course, it is also possible to configure the output to switch in another order.

The heating device 1 of this embodiment restricts the output selectable by the user's manipulation to outputs other than 1000 W. As is described below, an upper limit is provided on the period of time for which the heating unit 60 can continuously output microwaves at 1000 W. Restricting a user from selecting 1000 W through manual manipulation has an advantage in which the user does not feel dissatisfied due to the upper limit on the time for which the output is possible. After an output is selected by manipulating the microwave heating instruction key 31 once or a plurality of times, the output of the microwave function is determined when the start key 33 is manipulated.

The first manipulation unit 30 may also include other key manipulation units, such as a key manipulation unit that receives manipulation related to the oven function or the grill function of the heating device 1 and a key manipulation unit that receives manipulation related to the automatic heating function that heats the object to be heated in accordance with a predetermined program.

The dial 39 is a manipulation unit that receives rotation manipulations. Manipulation of rotating the dial 39 is, for example, a manipulation of inputting a numerical value. Specifically, rotating the dial 39 in the clockwise (CW) direction can increase the numerical value, and rotating the dial 39 in the counterclockwise (CCW) direction can decrease the numerical value. The numerical value to be input by dial 39 is, for example, the time for heating by the microwave function, that is, the heating time. When start key 33 is manipulated with a specific numerical value determined by rotating dial 39, the heating time input by dial 39 is determined. The dial 39 may also be capable of executing a manipulation to provide an instruction for switching of the output of the microwave function. For example, the configuration may be such that when the initial value of 600 W is selected as the output of heating device 1, a manipulation of rotating dial 39 clockwise switches the output to 800 W, and a manipulation of rotating dial 39 counterclockwise switches the output to 500 W, 300 W, and 150 W, in sequence. The output switching by manipulating the dial 39 may have a non-cyclical aspect.

In this way, a heating condition including the output of the microwave function and heating time are input by microwave heating instruction key 31, start key 33, and dial 39. When the start key 33 is manipulated after the heating condition are input, the heating device 1 heats the object to be heated in accordance with the heating condition.

The short-time heating key 41 is a dedicated key manipulation unit for instructing the heating device 1 to perform a short-time heating in microwave cooking. The short-time heating includes heating at a higher output than the heating condition input by manipulation of the microwave heating instruction key 31, start key 33, and dial 39. The short-time heating is an operation that ends heating in a shorter time than the heating condition. The short-time heating is an example of a “high-output heating”. When the microwave function is selected, the heating device 1 executes heating in accordance with the heating condition when the short-time heating key 41 is not manipulated, and the heating device 1 executes a short-time heating when the short-time heating key 41 is manipulated. The short-time heating key 41 corresponds to an example of a “high-output manipulation unit”.

In cooking instructions for various foods including processed foods, cooking recipes, and other cooking-related instructions, descriptions are often made that specify the microwave output and heating time. It is assumed that a user who uses the heating device 1 according to these descriptions will input the output and heating time written in the instructions using the microwave heating instruction key 31 and dial 39. On the other hand, if the heating device 1 has a function for heating at a higher output, the required heating can be completed in a shorter time by heating the object to be heated at an output higher than the output described in the instructions. However, in order to perform heating equivalent to the output and heating time described in the various instructions at a higher output, it is necessary to take into account the required heating amount to determine the output and heating time. It is a heavy burden and not easy for a user to make such a determination by himself. The heating device 1 of this embodiment can execute a short-time heating through a manipulation of the short-time heating key 41 after the user inputs the heating condition. In the short-time heating, the heating device 1 executes heating that matches the input heating condition using a higher output. This allows the user to perform the required heating in a shorter time with a method that the user can easily executes, improving user convenience.

The display unit 50 has a display panel such as a liquid crystal display panel or an organic electro luminescence (EL) panel, and displays letters and symbols. In the example of FIG. 2, the display unit 50 displays a numerical value display unit 51, a unit display 52, a start guide icon 53, and a short-time heating icon 54.

The numerical value display unit 51 displays a multi-digit numerical value. The numerical value display unit 51 displays, for example, the output value selected by manipulation of the microwave heating instruction key 31, the heating time input by manipulation of the dial 39, and the remaining heating time during heating.

The unit display 52 displays the unit of the numerical value displayed on the numerical value display unit 51. In this embodiment, the unit display 52 can display “W” corresponding to the case in which the numerical value display unit 51 displays an output, and “minutes” and “seconds” corresponding to the case in which the numerical value display unit 51 displays a time.

The start guide icon 53 is an image or a symbol that guides the user to manipulate the start guide icon 53. The start guide icon 53 is displayed, for example, after the heating time is selected with the dial 39.

The short-time heating icon 54 is an image or symbol related to a short-time heating of the heating device 1. The short-time heating icon 54 is displayed, for example, when a short-time heating can be executed by manipulating the short-time heating key 41 and when a short-time heating is being executed. Displaying the short-time heating icon 54 by the display unit 50 is an example of notifying that a short-time heating is possible, and the display unit 50 corresponds to an example of a “notification unit”.

### [1-1-3. Configuration of Control System of Heating Device]

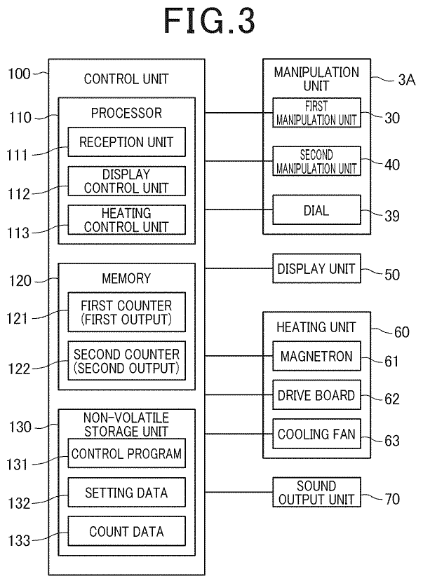

FIG. 3 is a block diagram of the heating device 1 in Embodiment 1.

The heating device 1 includes a control unit 100 that controls individual units of the heating device 1. The first manipulation unit 30, the dial 39, and the second manipulation unit 40 that constitute the manipulation unit 3A are connected to the control unit 100. When receiving a manipulation of the microwave heating instruction key 31, the cancel key 32, the start key 33, and any other key manipulation unit, the first manipulation unit 30 outputs a manipulation signal corresponding to the manipulated key manipulation unit to the control unit 100. The dial 39 outputs a manipulation signal indicating the rotation direction and rotation amount of the dial 39 to the control unit 100 in response to the manipulation of rotating the dial 39. When the second manipulation unit 40 receives a manipulation of the short-time heating key 41, it outputs a manipulation signal indicating the manipulation of the short-time heating key 41 to the control unit 100.

The display unit 50, the heating unit 60, and the sound output unit 70 are connected to the control unit 100. The heating unit 60 includes a magnetron 61 that outputs microwaves, a drive board 62 that supplies power to the magnetron 61 and controls the output thereof, and a cooling fan 63 that cools the magnetron 61. The heating unit 60 may also include a waveguide and an antenna (not shown).

The sound output unit 70 is a device that outputs a notification sound, and is a buzzer or other speaker. The sound output unit 70 corresponds to an example of a “notification unit”.

The control unit 100 includes a processor 110, a memory 120, and a non-volatile storage unit 130. The processor 110 is composed of a central processing unit (CPU), a micro processing unit (MPU), and the like. The memory 120 is a volatile storage device, and is composed of, for example, a random access memory (RAM). The memory 120 forms a work area that temporarily stores programs to be executed by the processor 110 and data. The non-volatile storage unit 130 is configured of, for example, a read only memory (ROM) or a flash memory, and stores programs to be executed by the processor 110 and data processed by the processor 110 in a non-volatile manner.

For example, the non-volatile storage unit 130 stores a control program 131, setting data 132, and count data 133.

The processor 110 reads and executes the control program 131 to function as a reception unit 111, a display control unit 112, and a heating control unit 113.

The reception unit 111 receives manipulations performed by the user on the manipulation unit 3A based on manipulation signals output by the first manipulation unit 30, the dial 39, and the second manipulation unit 40.

The display control unit 112 controls the display of the display unit 50 in accordance with manipulation contents received by the reception unit 111 and control of the heating unit 60 executed by the heating control unit 113.

The heating control unit 113 controls the heating unit 60 based on the manipulation contents received by the reception unit 111 and the state of the heating unit 60. Specifically, the heating control unit 113 determines the microwave output from the magnetron 61 and the time for outputting the microwaves, and controls the drive board 62 to cause the magnetron 61 to generate the microwaves.

The heating control unit 113 manages the operation state of the magnetron 61 to protect the magnetron 61. Specifically, the heating control unit 113 limits the time for which the magnetron 61 continuously outputs high output microwaves. For this limit, the heating control unit 113 stores a first counter 121 and a second counter 122 in the memory 120. The first counter 121 and the second counter 122 correspond to an example of “state data”.

The first counter 121 and the second counter 122 are counters that count the time for which the magnetron 61 outputs microwaves at an output higher than or equal to a predetermined output. In this embodiment, an example is described in which two counters are formed in the memory 120, but this is just an example, and the number of counters is not limited.

The output higher than or equal to a predetermined output is, for example, an output that exceeds the default output value, which is 600 W, of the microwave function of the heating device 1. In this embodiment, the outputs higher than or equal to a predetermined output are 1000 W and 800 W. In the following description, as an example, the magnetron 61 has two outputs higher than or equal to the predetermined output. These two outputs are referred to as a first output and a second output. The first output is the highest output to be used by the heating device 1 for heating, and is 1000 W in this embodiment. The second output is the second highest output after the first output to be used by the heating device 1 for heating, and is 800 W in this embodiment.

The count value per second that the heating control unit 113 adds to the first counter 121 is referred to as count value A, and the count value per second that the heating control unit 113 adds to the second counter 122 is referred to as count value B. The count value A includes a count value A1 and a count value A2. The count value A1 is the count value per second added to the first counter 121 while the magnetron 61 is outputting microwaves at 1000 W. The count value A2 is the count value per second added to the first counter 121 while the magnetron 61 is outputting microwaves at 800 W.

The count value B includes a count value B1 and a count value B2. The count value B1 is the count value per second added to the second counter 122 while the magnetron 61 is outputting microwaves at 1000 W. The count value B2 is the count value per second added to the second counter 122 while the magnetron 61 is outputting microwaves at 800 W.

The count values A1, A2, B1, and B2 may all be different values from each other, or may include a common value. The specific values of the count values A1, A2, B1, and B2 are appropriately set based on the specifications of the magnetron 61, or the like. For example, the count value A1 can be 10, the count value A2 can be 16, the count value B1 can be 12, and the count value B2 can be 14.

An upper limit value is set for each of the first counter 121 and the second counter 122. When the first counter 121 reaches its upper limit value, the heating control unit 113 stops the output of 1000 W from the magnetron 61. Similarly, when the second counter 122 reaches its upper limit value, the heating control unit 113 stops the output of 800 W from the magnetron 61. In other words, the count value of the first counter 121 limits the first output of the magnetron 61, and the count value of the second counter 122 limits the second output of the magnetron 61. The upper limit values of the first counter 121 and the second counter 122 may be the same value or different values. These specific values are set appropriately based on the specifications of the magnetron 61, or the like. For example, the upper limit value of the first counter 121 can be set to 1500, and the upper limit value of the second counter 122 can be set to 5000. When the first output is set to be higher than the second output as described above, the upper limit value of the first counter 121 is preferably lower than or equal to the upper limit value of the second counter 122.

The heating control unit 113 subtracts the count values of the first counter 121 and the second counter 122 while the magnetron 61 is not outputting microwaves. This corresponds to a decrease in the temperature of the magnetron 61 while the magnetron 61 is stopped. Subtraction values per second which the heating control unit 113 subtracts from the first counter 121 and the second counter 122 may be the same value or different values. These specific values are set appropriately based on the specifications of the magnetron 61, or the like. For example, the subtraction value per second of the first counter 121 can be set to 10, and the subtraction value per second of the second counter 122 can be set to 10.

The count values A1, A2, B1, and B2, the upper limit value and subtraction value of the first counter 121, and the upper limit value and subtraction value of the second counter 122 are, for example, included in the setting data 132 and stored in the non-volatile storage unit 130. The heating control unit 113 performs processing related to the first counter 121 and the second counter 122 in accordance with the setting data 132. The difference between the count value and the upper limit value of the first counter 121 corresponds to the time for which microwaves can be output at the first output, and indicates an output possible time of the first output. The difference between the count value and the upper limit value of the second counter 122 corresponds to the time for which microwaves can be output at the second output, and indicates an output possible time of the second output.

Since the memory 120 is a volatile storage device, the count values of the first counter 121 and the second counter 122 may be lost when the heating device 1 is powered off. For example, if the heating device 1 is powered on again in a short time after being powered off, the count values of the first counter 121 and the second counter 122 become zero regardless of the temperature of the magnetron 61. In such a case, it is difficult to efficiently manage the magnetron 61. Therefore, in this embodiment, the heating control unit 113 stores the count values of the first counter 121 and the second counter 122 in the non-volatile storage unit 130 as count data 133 in response to the operating state of the heating device 1. Specifically, the heating control unit 113 stores the count data 133 in the non-volatile storage unit 130 when the heating device 1 stops heating and when the heating device 1 is powered off. If the count data 133 has already been stored in the non-volatile storage unit 130, the heating control unit 113 updates the count data 133. When the count values of the first counter 121 and the second counter 122 are lost, the heating control unit 113 sets the count values of the first counter 121 and the second counter 122 based on the count data 133. This allows the state of the magnetron 61 to be appropriately managed even if the count values of the first counter 121 and the second counter 122 are lost due to a power cut-off or the like. The count data 133 corresponds to an example of “state data”.

The heating control unit 113 executes a short-time heating in response to the manipulation of the short-time heating key 41. The short-time heating is operation in which the magnetron 61 is operated at a higher output than the heating condition input by manipulating the first manipulation unit 30 and the dial 39. Performing the short-time heating makes it possible to complete the heating of the object to be heated in a shorter time than the heating condition.

When executing a short-time heating, the heating control unit 113 determines the output of the magnetron 61 and the heating time for executing the short-time heating. At this time, the heating control unit 113 determines the output and heating time such that the heating amount of the short-time heating corresponds to the heating amount when the heating condition input by the user is executed. The heating amount can be said to be energy given to the object to be heated in the heating chamber 7, and can be approximated by the microwave energy output by the magnetron 61. In this embodiment, the energy of the microwaves output from the magnetron 61 is regarded as the heating amount. Specifically, the value obtained by multiplying the output of the magnetron 61 by the heating time is used as an index of the heating amount.

For example, when the heating condition is 600 W and 5 minutes, the heating control unit 113 calculates an index value for the heating amount with the following expression (1).

$$600 [ W ] \times 300 [ sec ] = 180 , 000 \qquad ( 1 )$$

Here, the heating amount for executing the heating condition input by a user is called the specified heating amount. The heating amount for a short-time heating is the heating amount corresponding to the specified heating amount. The corresponding heating amount means, for example, that the short-time heating has an index value of the heating amount that is the same as the index value of the specified heating amount, or means that the short-time heating has an index value of the heating amount that is greater than the index value of the specified heating amount in which the difference between the two index values is within a preset range. Alternatively, the corresponding heating amount may include that the short-time heating has an index value of the heating amount that is smaller than the index value of the specified heating amount in which the difference between the two index values is within a preset range.

The heating control unit 113 determines the output and heating time for the short-time heating such that the output and heating time includes an output higher than the heating condition and can obtain a heating amount corresponding to the specified heating amount. Hereinafter, a combination of an output and a heating time for a short-time heating is referred to as a short-time heating condition.

For example, if the heating condition is 600 W and 5 minutes, the heating control unit 113 generates a short-time heating condition that includes at least one of 800 W and 1000 W and corresponds to an index value of 180,000.

The heating control unit 113 generates a short-time heating condition based on the operation history of the magnetron 61 in addition to the heating amount. Specifically, the heating control unit 113 generates a short-time heating condition such that the count values of the first counter 121 and the second counter 122 do not exceed their upper limit values. For example, when the heating condition is 600 W and 5 minutes, using only the output of 1,000 W and setting the index value to 180,000 leads to the heating time of 180 seconds.

Here, when the count value of the first counter 121 exceeds the upper limit value due to 180 seconds of heating, the heating control unit 113 generates a short-time heating condition including heating at a lower output in addition to heating at 1000 W. In other words, the heating time of 1000 W is set to a time that does not exceed the upper limit value, and heating is performed with an output included in the input heating condition. Here, the heating control unit 113 may preferentially employ the input heating condition of 500 W. For example, the heating control unit 113 generates a short-time heating condition including heating of 1000 W and 2 minutes and heating of 500 W and 2 minutes, corresponding to a heating condition of 600 W and 5 minutes. The index value of the heating amount for this short-time heating condition is calculated with the expression (2) described below. In this example, the period in which 1000 W is output corresponds to an example of a “first period”, and the period in which 500 W is output corresponds to an example of a “second period”. The first period only needs to be a period in which an output higher than the heating condition is performed, and may be a period in which an output of 800 W or 600 W is performed, for example. In addition, in the process of generating a short-time heating condition, the heating control unit 113 may generate a short-time heating condition in which the heating time of 1000 W is set to a time that does not exceed an upper limit value, and the remaining heating is performed at an output lower than 1000 W and higher than the heating condition. For example, if the heating condition include an output of 500 W, the heating control unit 113 may generate a short-time heating condition including heating at 800 W or 600 W in addition to heating at 1000 W.

$$1000 [ W ] \times 120 [ sec ] + 500 [ W ] \times 120 [ sec ] = 180000 \qquad ( 2 )$$

The heating control unit 113 determines whether a short-time heating is possible. For example, if the heating time cannot be shortened by using the short-time heating condition compared to the heating condition having been input, or if the time to be shortened is below a predetermined threshold value, there is little point in employing the short-time heating condition. In this case, the heating control unit 113 determines that no short-time heating is possible. When the heating control unit 113 determines that a short-time heating is possible, the display control unit 112 causes the display unit 50 to display the short-time heating icon 54. Also, the display control unit 112 causes the display unit 50 to display the short-time heating icon 54 while a short-time heating is being executed. In order to make it possible to distinguish between the display states of the short-time heating icon 54, for example, the display control unit 112 may cause the short-time heating icon 54 to blink before short-time heating is executed, and may cause the short-time heating icon 54 to be constantly displayed while the short-time heating is being executed.

When heating in accordance with the input heating condition or a short-time heating is executed, the heating control unit 113 causes the sound output unit 70 to output a notification sound when heating has ended.

### 1-2. Operation

### [1-2-1. Operation of Heating Device]

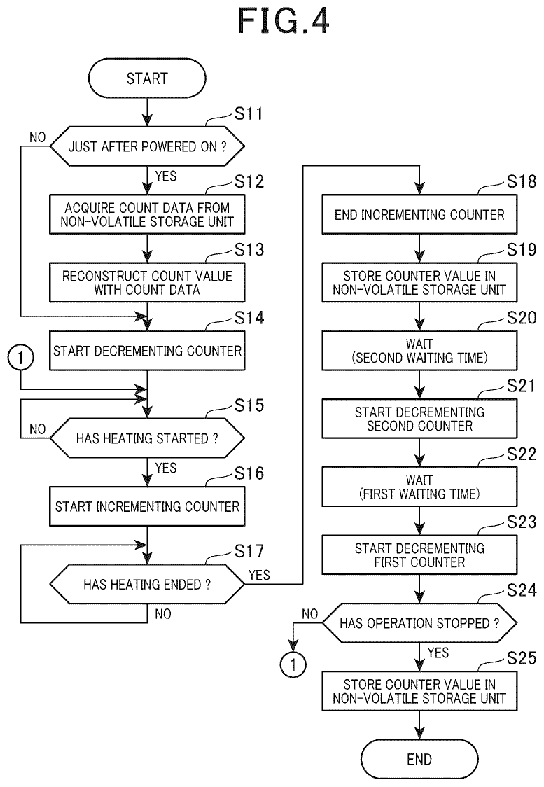

FIGS. 4, 5, and 6 are flowcharts showing an example of the operation of the heating device 1 in Embodiment 1.

FIG. 4 shows the operation related to the first counter 121 and the second counter 122. Steps S11 to S25 in FIG. 4 are executed by the heating control unit 113.

The operation of FIG. 4 starts at least any of the following: after the heating device 1 is powered on, after the heating device 1 ends heating, and at any other specified timing.

The control unit 100 refers to the processor 110 and determines whether the heating device 1 has just been powered on (step S11). Here, the heating device 1 being powered on includes, for example, the heating device 1 being supplied with power in a state of having been completely powered off, and the heating device 1 being returned to a normal operation state from a power saving state. The power saving state is a state of stopping the individual units of the heating device 1 including the control unit 100 or a state of reducing the frequency of operation of the individual units to reduce the power consumption of the heating device 1. The power saving state is called, for example, a sleep state. For example, if the heating device 1 is configured to stop supplying power to the volatile memory 120 in a power saving state, the control unit 100 determines that the time immediately after the heating device 1 returns from the power saving state is the time immediately after the heating device 1 is powered on (step S11: YES).

When the power has just been turned on (step S11: YES), it is highly likely that the count values of the first counter 121 and the second counter 122 have been lost. For this reason, the control unit 100 acquires the count data 133 from the non-volatile storage unit 130 (step S12). The control unit 100 restores the count values of the first counter 121 and the second counter 122 using the count data 133 (step S13), and proceeds to step S14. When the heating device 1 is powered on but not immediately after being powered on (step S11: NO), the control unit 100 proceeds to step S14.

In step S14, the control unit 100 starts decrementing the first counter 121 and the second counter 122 (step S14). The control unit 100 determines whether heating with the heating unit 60 has started (step S15). If heating has not started (step S15: NO), the control unit 100 continuously subtracts the count values and keeps waiting.

If heating has been started (step S15: YES), the control unit 100 starts adding the count values of the first counter 121 and the second counter 122 (step S16). Specifically, while the magnetron 61 is performing heating at the first output, the count value of the first counter 121 is added, and while the magnetron 61 is performing heating at the second output, the count value of the second counter 122 is added. Also, when the first output is higher than the second output, the control unit 100 may add the count values of both the first counter 121 and the second counter 122 while the magnetron 61 is performing heating at the first output.

The control unit 100 determines whether heating with the heating unit 60 has ended (step S17). If heating has not ended (step S17: NO), the control unit 100 continuously adds the count value and keeps waiting. If heating ends (step S17: YES), the control unit 100 ends addition of the count value (step S18), and overwrites the count data 133 with the count values of the first counter 121 and the second counter 122 to store the count values in the non-volatile storage unit 130 (step S19).

The control unit 100 waits for a preset second waiting time (step S20) and then starts decrementing the second counter 122 (step S21). Furthermore, the control unit 100 waits for a preset first waiting time (step S22) and then starts decrementing the first counter 121 (step S23). The second waiting time is a waiting time from when the magnetron 61 stops until the second counter 122 is decremented. For the first counter 121, the sum of the first waiting time and the second waiting time is set as the waiting time from when the magnetron 61 stops until the first counter 121 is decremented. The first waiting time and the second waiting time are restrictions set for subtracting the count value after the temperature of the magnetron 61 drops, and may be omitted depending on the specifications of the magnetron 61 or the like.

The control unit 100 determines whether a condition for stopping the operation of the heating device 1 have been met (step S24). Stopping the operation includes, for example, transitioning to the power saving state described above. This condition is, for example, that a period, in which the manipulation panel 3 is not manipulated and the heating unit 60 is not operated, continues for a set time or longer. If the condition is met (step S24: YES), the control unit 100 overwrites the count data 133 with the count values of the first counter 121 and the second counter 122 to store the count values in the non-volatile storage unit 130 (step S25). If the condition is not met (step S24: NO), the control unit 100 returns to step S15.

In FIG. 4, the operation of the heating device 1 has been described as a flow, but an interrupt process may be performed in response to a manipulation on the manipulation panel 3, and the like. For example, if heating with the heating unit 60 is started in the waiting time of steps S20 and S22, or at other timings, the control unit 100 may start incrementing the first counter 121 and the second counter 122 by the interrupt process (step S16).

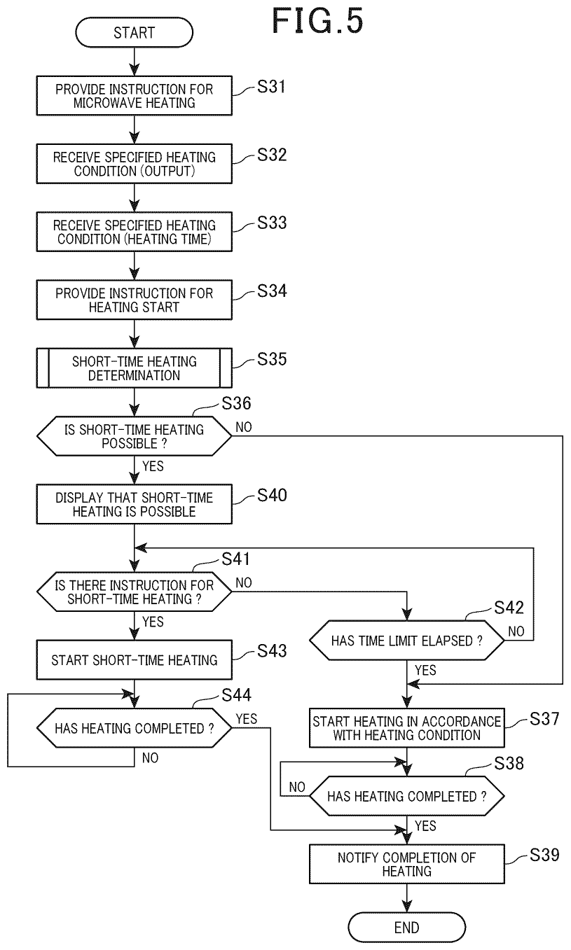

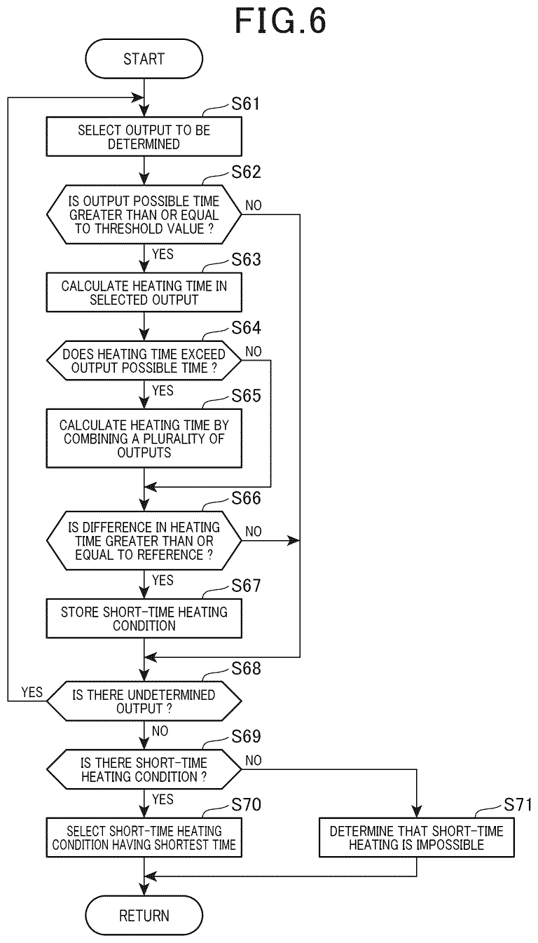

FIGS. 5 and 6 show the operation of the heating device 1 to heat the object to be heated. Steps S31 to S34 are executed by the reception unit 111, steps S35 to S39 and S41 to S44 are executed by the heating control unit 113, and step S40 is executed by the display control unit 112.

The operation of FIG. 5 is triggered by the receipt of a manipulation with the manipulation unit 3A.

The control unit 100 receives an instruction for microwave heating with the microwave heating instruction key 31 (step S31). The control unit 100 receives a microwave output specified by the microwave heating instruction key 31 or the dial 39 (step S32), and receives a heating time specified by the dial 39 (step S33). If the control unit 100 receives an instruction for starting heating by manipulation of the start key 33 (step S34), the control unit 100 executes a short-time heating determination process (step S35).

A short-time heating determination process is a process for determining whether short-time heating is possible and generating a short-time heating condition. FIG. 6 shows details of the short-time heating determination process.

Steps S61 to S71 in FIG. 6 are executed by the heating control unit 113.

The control unit 100 selects an output to be determined whether it can be used for a short-time heating among the outputs executable by the heating device 1 (step S61). Specifically, the control unit 100 selects any one of the outputs higher than the heating condition received in steps S32 and S33 among the outputs executable by the heating device 1 (step S61). The control unit 100 determines whether the output possible time of the output selected in step S61 is greater than or equal to a threshold value (step S62). For example, the control unit 100 calculates the possible output time (seconds) by dividing the difference between the count value of the counter and the upper limit value corresponding to the selected output by the value to be added per second. The control unit 100 compares the output possible time with a preset threshold, and makes a negative determination if the output possible time is below the threshold value.

If the output possible time is not larger than or equal to the threshold value (step S62: NO), the control unit 100 proceeds to step S68, which is described below.

If the output possible time is greater than or equal to the threshold value (step S62: YES), the control unit 100 calculates a heating time for obtaining a heating amount corresponding to the heating condition, with the output selected in step S61 (step S63). The control unit 100 determines whether the heating time calculated in step S63 exceeds the output possible time (step S64). If the calculated heating time exceeds the output possible time (step S64: YES), the control unit 100 calculates a heating time for obtaining the heating amount corresponding to the heating condition by combining a plurality of outputs (step S65). In step S65, the control unit 100 generates a short-time heating condition including, for example, the output selected in step S63 and the output specified as the heating condition, and calculates the total heating time for the short-time heating. After the process of step S65, the control unit 100 proceeds to step S66. If the calculated heating time does not exceed the output possible time (step S64: NO), the control unit 100 proceeds to step S66.

In step S66, the control unit 100 determines whether the difference between the calculated heating time and the heating time specified as the heating condition is greater than or equal to a reference (step S66). If the difference in heating times is smaller than the reference (step S66: NO), the control unit 100 proceeds to step S68, which is described below. This means that the heating device 1 does not execute the short-time heating that has a small effect in shortening the heating time, and can prevent the user's expectation for the short-time heating from being disappointed.

If the difference in heating times is greater than or equal to the reference (step S66: YES), the control unit 100 temporarily stores the short-time heating condition in the memory 120 (step S67) and proceeds to step S68.

In step S68, the control unit 100 determines whether an undetermined output is present among outputs that are executable by the heating device 1 and are higher than the output specified as the heating condition (step S68). In other words, the control unit 100 determines whether an output is present that has not been selected as an output to be determined in step S61. If an undetermined output (step S68: YES) is present, the control unit 100 returns to step S61.

If no undetermined output is present (step S68: NO), the control unit 100 determines whether there is a short-time heating condition stored in the memory 120 (step S69). If a short-time heating condition is present (step S69: YES), the control unit 100 selects the short-time heating condition with the shortest heating time (step S70) and proceeds to step S36 in FIG. 5. If no corresponding short-time heating condition is present (step S69: NO), the control unit 100 determines that any short-time heating is impossible (step S71) and proceeds to step S36 in FIG. 5.

Returning to FIG. 5, the control unit 100 determines whether a short-time heating is possible (step S36) based on the result of the short-time heating determination process (step S35). If no short-time heating is determined to be possible (step S36: NO), the control unit 100 starts heating with the heating unit 60 in accordance with the heating condition received in steps S32 and S33 (step S37). The control unit 100 waits until the heating is completed (step S38), and notifies the completion of the heating after the heating is completed, (step S39). In step S39, the control unit 100 causes, for example, the sound output unit 70 to output a notification sound.

If the short-time heating condition is selected in the short-time heating determination process (step S35), the control unit 100 determines in step S36 that a short-time heating is possible (step S36: YES). In this case, the control unit 100 blinks the short-time heating icon 54 on the display unit 50 to display that short-time heating is possible (step S40). The blinking display of the short-time heating icon 54 corresponds to a notification that short-time heating is possible. The control unit 100 determines whether an instruction for the short-time heating has been provided (step S41). Specifically, the instruction for the short-time heating is the manipulation of the short-time heating key 41.

If no instruction for short-time heating has been provided (step S41: NO), the control unit 100 determines whether a preset time limit has elapsed after displaying that the short-time heating is possible (step S42). If the time limit has not elapsed (step S42: NO), the control unit 100 returns to step S41. If the time limit has elapsed (step S42: YES), the control unit 100 proceeds to step S37.

If the instruction for the short-time heating has been provided (step S41: YES), the control unit 100 starts heating with the heating unit 60 (step S43) in accordance with the short-time heating condition selected in the short-time heating determination process (step S35). The control unit 100 waits until the heating is completed (step S44), and proceeds to step S39 after heating is completed.

### [1-2-2. Transition of Display in Heating Device]

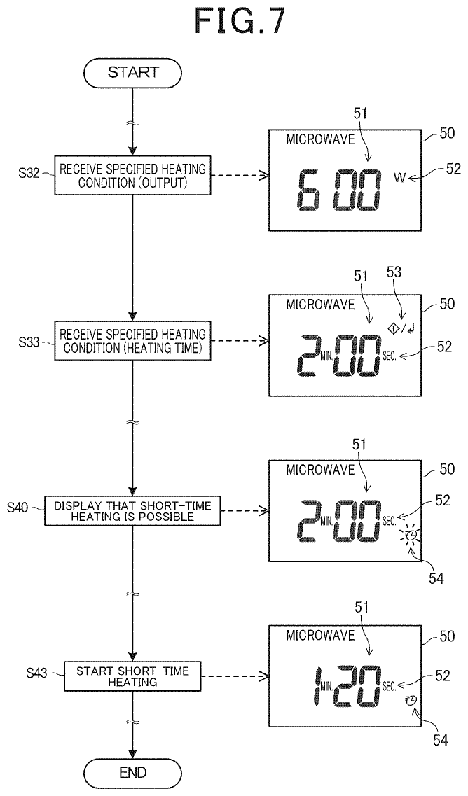

FIG. 7 is an explanatory diagram showing an example of the display transition of the heating device 1 in Embodiment 1, and shows the operation shown in FIG. 5 in association with the display state of the display unit 50.

If an output is specified by manipulating the microwave heating instruction key 31 (step S32), the display control unit 112 causes the specified output to be displayed on the numerical value display unit 51. If the heating time is specified by manipulating the dial 39 (step S33), the display control unit 112 causes the specified heating time to be displayed on the numerical value display unit 51. After specifying the heating time, the user can start heating by manipulating the start key 33. For this, the display control unit 112 displays the start guide icon 53 on the display unit 50 to inform the user that manipulation of the start key 33 is possible.

When a short-time heating is determined to be possible by the short-time heating determination process (FIG. 6), the display control unit 112 causes the display unit 50 to blink the short-time heating icon 54. The blinking display of the short-time heating icon 54 informs the user that heating can be completed in a shorter time than the heating condition input by the user.

If the short-time heating key 41 is manipulated within the limit time while the short-time heating icon 54 is blinking, the heating control unit 113 starts the short-time heating. At this time, the display control unit 112 switches the blinking display of the short-time heating icon 54 to a constant display. This informs the user that the short-time heating is being executed.

### 1-3. Effects and the Like

As described above, the heating device 1, which heats an object to be heated with the heating unit 60, includes the heating unit 60 capable of outputting microwaves at a plurality of different outputs, and the manipulation unit 3A that receives input of a heating condition including the heating time and the output of the heating unit 60. The heating device 1 includes a control unit 100 that operates the heating unit 60 based on a heating condition. The manipulation unit 3A includes a short-time heating key 41 that provides an instruction for a short-time heating, which includes operating the heating unit 60 at a higher output than the heating condition.

This makes it possible, through a simple manipulation, to provide an instruction for an operation to heat the object to be heated at an output higher than the output specified by the user. This improves the user's convenience regarding heating and cooking.

The short-time heating key 41 receives an instruction for a short-time heating that includes operating the heating unit 60 at the maximum output of the heating unit 60.

This makes it possible to use the maximum output of the heating device 1 to perform heating in a shorter time.

The control unit 100 determines the heating time for a short-time heating such that the heating amount in the short-time heating corresponds to the heating condition.

This makes it possible to perform the short-time heating to obtain a heating amount corresponding to the heating condition input by the user, and to perform the required heating in a shorter time.

The control unit 100 determines the heating time of the heating unit 60 when performing a short-time heating based on the heating amount applied to the object to be heated and the operation history of the heating unit 60.

This makes it possible to avoid an excessive load or the like on the heating unit 60 and perform the short-time heating, and to heat the object to be heated appropriately in a shorter time.

The control unit 100 acquires the output possible time for which the heating unit 60 can output microwaves at a higher output than the heating condition. The control unit 100 determines a heating time and an output of the heating unit 60 in a short-time heating such that the time for which the heating unit 60 is operated at an output higher than the heating condition does not exceed the output possible time and such that the heating amount in the short-time heating is set to the heating amount corresponding to the heating condition.

This makes it possible to operate the heating unit 60 not to exceed the limit and perform the short-time heating, and to heat the object to be heated appropriately in a shorter time.

If the heating time exceeds the output possible time for setting the heating amount in a short-time heating to the heating amount corresponding to the heating condition, the control unit 100 executes a short-time heating including the first period and the second period. The first period is a period in which the heating unit 60 is operated at a higher output than the heating condition. The second period is a period in which the heating unit 60 is operated at an output included in the heating condition.

This makes it possible to use a plurality of outputs to perform the necessary heating in a shorter time.

The control unit 100 determines the lengths of the first and second periods such that the sum of the heating amount in the first period and the heating amount in the second period is the heating amount corresponding to the heating condition.

This makes it possible to use a plurality of outputs to perform the necessary heating in a shorter time.

The heating device 1 includes an notification unit. The notification unit includes, for example, a display unit 50 that displays the short-time heating icon 54, and a sound output unit 70. If the output possible time is greater than or equal to the threshold value, the control unit 100 causes the notification unit to notify that a short-time heating is possible.

This allows the user to be informed that a short-time heating can be executed, and allows the user to manipulate the short-time heating key 41 in response to the notification and complete heating more easily in a shorter time. This makes it possible to improve the user's convenience regarding heating and cooking.

When the heating time for performing a short-time heating is shorter than the heating condition, the control unit 100 causes the notification unit to notify the user that the short-time heating is possible.

This allows the user to more reliably shorten the heating time by manipulating the short-time heating key 41 in response to the notification.

After the control unit 100 receives a manipulation with the manipulation unit 3A to provide an instruction for the start of heating, the control unit 100 causes the notification unit to notify the user that a short-time heating is possible.

This notifies that the short-time heating can be executed after the heating condition input by the user is settled. This allows the user to more reliably shorten the heating time by manipulating the short-time heating key 41 in response to the notification.

After the control unit 100 notifies that a short-time heating is possible, if a state in which the short-time heating key 41 is not manipulated continues for a predetermined time or more, the control unit 100 operates the heating unit 60 in accordance with the heating condition.

According to this, when the user does not want to perform any short-time heating, heating is promptly executed based on the heating condition input by the user. This makes it possible to improve the user's convenience regarding heating and cooking.

The heating device 1 includes a memory 120 that temporarily stores data, and a non-volatile storage unit 130 that stores data in a non-volatile manner. The control unit 100 stores a first counter 121 and a second counter 122 indicating the operation state of the heating unit 60 in a memory, and updates the first counter 121 and the second counter 122 in response to the operation of the heating unit 60. The control unit 100 calculates the output possible time based on the first counter 121 and the second counter 122. When the operating state of the heating device 1 is in a predetermined state, the control unit 100 stores count data 133 indicating the count values of the first counter 121 and the second counter 122 in the non-volatile storage unit 130. The control unit 100 then reads out the count data 133 from the non-volatile storage unit 130 and stores it in the memory 120.

This makes it possible to store the first counter 121 and the second counter 122 related to the state of the heating unit 60 in the memory 120, thereby easily updating the first counter 121 and the second counter 122. Furthermore, this makes it possible to store the count data 133 in the non-volatile storage unit 130, thereby preparing for the disappearance of the first counter 121 and the second counter 122. As a result, the state of the heating unit 60 can be appropriately managed.

The heating device 1, which heats an object to be heated with the heating unit 60, includes the heating unit 60 capable of outputting microwaves at a plurality of different outputs, and the manipulation unit 3A that receives input of a heating condition including the heating time and the output of the heating unit 60. The heating device 1 includes a control unit 100 that operates the heating unit 60 based on a heating condition. The manipulation unit 3A includes a short-time heating key 41 that provides an instruction for a short-time heating, which includes operating the heating unit 60 at a higher output than the heating condition. The control unit 100 acquires the output possible time for which the heating unit 60 can output microwaves at a higher output than the heating condition. The control unit 100 determines a heating time and an output of the heating unit 60 in a short-time heating such that the time for which the heating unit 60 is operated at an output higher than the heating condition does not exceed the output possible time and such that the heating amount in the short-time heating is set to the heating amount corresponding to the heating condition.

This makes it possible, through a simple manipulation, to provide an instruction for an operation to heat the object to be heated at an output higher than the output specified by the user. The heating unit 60 can be operated so as not to exceed the limit to perform the short-time heating. This improves the user's convenience regarding heating and cooking.

The heating device 1 is configured to be capable of outputting microwaves at a plurality of different outputs. The heating device 1 includes a heating unit 60 that heats an object to be heated, and a manipulation unit 3A that receives input of a heating condition including the heating time and the output of the heating unit 60. The heating device 1 includes a control unit 100 that operates the heating unit 60 based on a heating condition. The control unit 100 acquires the output possible time for which the heating unit 60 can output microwaves at a higher output than the heating condition. The control unit 100 determines a heating time and an output of the heating unit 60 in a short-time heating such that the time for which the heating unit 60 is operated at an output higher than the heating condition does not exceed the output possible time and such that the heating amount in the short-time heating is set to the heating amount corresponding to the heating condition.

This makes it possible, through a simple manipulation, to provide an instruction for an operation to heat the object to be heated at an output higher than the output specified by the user. The heating unit 60 can be operated so as not to exceed the limit to perform the short-time heating. This improves the user's convenience regarding heating and cooking.

The heating device 1, which heats an object to be heated with the heating unit 60, includes the heating unit 60 capable of outputting microwaves at a plurality of different outputs, and the manipulation unit 3A that receives input of a heating condition including the heating time and the output of the heating unit 60. The heating device 1 includes a control unit 100 that operates the heating unit 60 based on a heating condition. The control unit 100 executes a short-time heating, which includes operating the heating unit 60 at an output higher than the heating condition.

This makes it possible to heat the object to be heated at an output higher than the output specified by the user, thereby heating the object in a shorter time. This improves the user's convenience regarding heating and cooking.

The control method for a heating device of the present disclosure is a control method for a heating device 1 that includes a heating unit 60 capable of outputting microwaves at a plurality of different outputs and a manipulation unit 3A that receives input of a heating condition including the heating time and the output of the heating unit 60. This control method executes a short-time heating that includes operating the heating unit 60 based on the heating condition with the control unit 100 that controls the heating unit 60, and operating the heating unit 60 at a maximum output higher than the heating condition in response to manipulation of the short-time heating key 41 provided on the manipulation unit 3A.

This exhibits the same effects as the heating device 1 described above.

The control method for a heating device of the present disclosure is a control method for a heating device 1 that includes a heating unit 60 capable of outputting microwaves at a plurality of different outputs and a manipulation unit 3A that receives input of a heating condition including the heating time and the output of the heating unit 60. This control method is a control method that executes a short-time heating that includes operating the heating unit 60 based on the heating condition with the control unit 100 that controls the heating unit 60, and operating the heating unit 60 at a maximum output higher than the heating condition in response to manipulation of the short-time heating key 41 provided on the manipulation unit 3A. In this control method, the control unit 100 acquires the output possible time for which the heating unit 60 can output microwaves at a higher output than the heating condition. The control unit 100 determines a heating time and an output of the heating unit 60 in a short-time heating such that the time for which the heating unit 60 is operated at an output higher than the heating condition does not exceed the output possible time and such that the heating amount in the short-time heating is set to the heating amount corresponding to the heating condition.

This exhibits the same effects as the heating device 1 described above.

The control program 131 of the present disclosure is a program that causes a processor 110 to function, in which the processor 110 controls a heating device 1 that includes a heating unit 60 capable of outputting microwaves at a plurality of different outputs, and a manipulation unit 3A that receives input of a heating condition including the heating time and the output of the heating unit 60. The control program 131 causes the processor 110 to function as the control unit 100. The control unit 100 operates the heating unit 60 based on the heating condition, and executes a short-time heating that includes operating the heating unit 60 at a maximum output higher than the heating condition in response to manipulation of the short-time heating key 41 provided on the manipulation unit 3A.

This exhibits the same effects as the heating device 1 described above.

### Embodiment 2

### 2-1. Operation of Heating Device

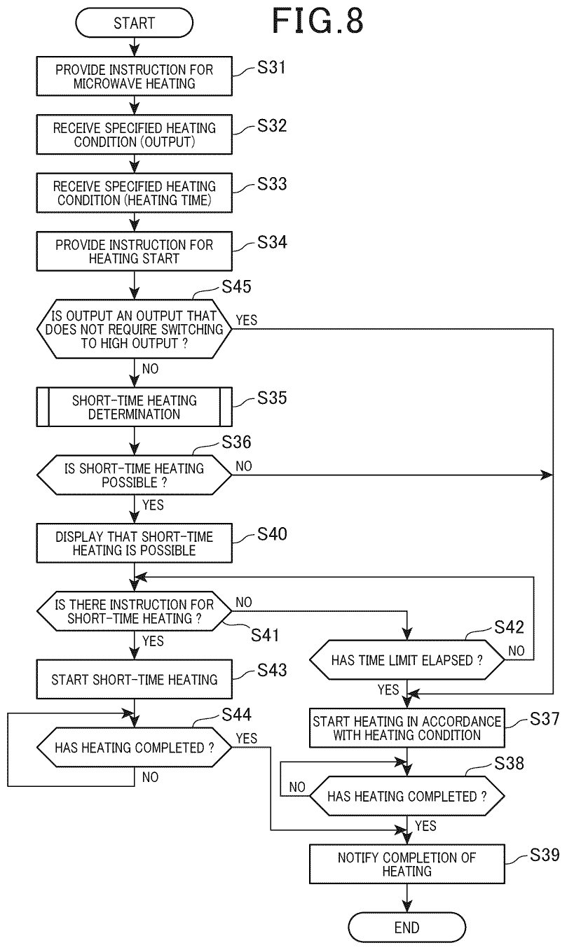

FIG. 8 is a flowchart showing an example of operation of the heating device 1 in Embodiment 2.

The configuration of the heating device 1 in Embodiment 2 is the same as that of the heating device 1 described in Embodiment 1. In the flowchart of FIG. 8, the same step numbers are given to processes that are common to the operations described in FIG. 5, and the description thereof is omitted.

In the Embodiment 2, when the start key 33 is manipulated (step S34), the control unit 100 determines whether the output having been input in step S32 is an output that does not require switching to high output (step S45). An output that does not require switching to high output is, for example, a low output among a plurality of outputs in the microwave oven function of the heating device 1. Specifically, a configuration is assumed in which the magnetron 61 is capable of outputting microwaves at six levels of output: 150 W, 300 W, 500 W, 600 W, 800 W, and 1000 W. In this case, the user can manipulate the microwave heating instruction key 31 or dial 39 to select an output to be used for heating the object to be heated from five levels of output: 150 W, 300 W, 500 W, 600 W, and 800 W. In this configuration, the lowest output of 150 W and the second lowest output of 300 W are set as outputs that do not require switching to high output. There may be only one output that does not require switching to high output, or there may be a plurality of outputs that do not require switching to high output.

The user can easily understand that when the heating device 1 performs heating at a low output, the heating time is longer than when the heating device 1 performs heating at other outputs. For this reason, when a low output is specified by the user's manipulation, it is presumed that the user intends to heat with a low output and a long heating time. In such a case, even if the short-time heating icon 54 is displayed, the user is unlikely to select the short-time heating. For this reason, if one or a plurality of the lowest outputs among the outputs selectable in the heating device 1 are preset as outputs that do not require switching to high output, processing related to the short-time heating can be omitted, which is efficient.

If the control unit 100 determines that the output having been input is an output that does not require switching to high output (step S45: YES), the control unit 100 proceeds to step S37 and starts heating in accordance with the heating condition. Furthermore, if it is determined that the output having been input in step S32 is not an output that does not require switching to high output (step S45: NO), the control unit 100 proceeds to step S35 and executes a short-time heating determination process.

In this way, in Embodiment 2, if the output specified by the user is an output that does not require switching to high output (step S45: YES), heating is promptly started in accordance with the heating condition. In this case, the short-time heating determination process and the process of blinking the short-time heating icon 54 are omitted. This shortens the user's waiting time and allows for more efficient heating.

### 2-2. Effects and the Like

When it is highly likely that the user does not want any short-time heating, the heating device 1 of Embodiment 2 makes it possible to omit the short-time heating determination process and the process of blinking the short-time heating icon 54, and to quickly execute heating in accordance with the heating condition, in addition to the effects described in Embodiment 1. This can shorten the user's waiting time and improve the processing efficiency of the heating device 1.

### Other Embodiments

As described above, Embodiments 1 and 2 are described as examples disclosed in this application. However, the technique in the present disclosure is not limited to this, and can be applied to embodiments in which changes, substitutions, additions, omissions, or the like are made. In addition, it is also possible to combine the individual components described in the above Embodiments 1 and 2 to form new embodiments.

For this reason, other embodiments are exemplified below.

For example, in the above-described embodiments, an example is described in which the dial 39 is included as a component for inputting the heating time, but this is just an example. For example, there may be a configuration in which the first manipulation unit 30 is provided with a plurality of time setting keys to which times are allocated and the heating time can be input with these time setting keys.

In the above-described embodiments, a heating device 1 having a plurality of heating means including heater heating and microwave heating are described as an example. However, the present disclosure is also applicable to a heating device having only a microwave function using microwave heating as heating means. The heating device 1 only needs to be configured to perform microwave heating at a plurality of outputs, and there are no limitations on the maximum and minimum outputs of the heating device 1 and the number of outputs. The present disclosure is also applicable to any of commercial heating devices 1 and a home heating devices 1.

The configuration of the heating device 1 shown in FIG. 3 is an example, and the specific implementation form is not particularly limited. In other words, it is not necessarily required to implement hardware corresponding to each unit individually, and it is also possible to configure such that one processor executing a program realizes the functions of the individual units. Furthermore, some of the functions realized by software in the above-described embodiments may be realized by hardware, or some of the functions realized by hardware may be realized by software.

The “program” of the above-described embodiments can also be recorded in a non-transitory manner, for example, on a recording medium readable by the processor 110. The recording medium to be used may be a magnetic or optical recording medium or a semiconductor memory device. In addition, these programs can be stored in a server device or the like, and the heating device 1 can download the programs from the server device to realize the above-described operations.

The processor 110 may be configured with a single processor, or may be configured with a plurality of processors. These processors may be hardware programmed to realize the corresponding functional units. In other words, these processors may be configured, for example, with an application specific integrated circuit (ASIC) or a field programmable gate array (FPGA).

The operation shown in FIGS. 5 to 8 has the step units into which the operation is divided according to the main processing contents in order to make the operation easier to understand, and the operation is not limited by the way of dividing into the processing units or their names. The operation may be divided into more step units depending on the processing contents. Also, the operation may be divided such that one step unit includes further more processes. The order of the steps may be changed appropriately within the scope of the present disclosure.

Note that the above-described embodiments are for illustrating the technique according to the present disclosure, and therefore various changes, substitutions, additions, omissions, or the like can be made within the scope of the claims or equivalents thereof.

### Supplements

The above description of the embodiment discloses the following techniques.

(Technique 1) A heating device that heats an object to be heated with a heating unit, the device including: a heating unit capable of outputting microwaves at a plurality of different outputs; a manipulation unit that receives input of a heating condition including a heating time and an output of the heating unit; and a control unit that operates the heating unit based on the heating condition, wherein the manipulation unit includes a high-output manipulation unit that provides an instruction for a high-output heating including operating the heating unit at an output higher than the heating condition. This makes it possible, through a simple manipulation, to provide an instruction for an operation to heat the object to be heated at an output higher than the output specified by the user. This improves the user's convenience regarding heating and cooking.

(Technique 2) The heating device according to Technique 1, wherein the high-output manipulation unit receives an instruction for the high-output heating including operating the heating unit at a maximum output of the heating unit.

This makes it possible to use the maximum output of the heating device to perform heating in a shorter time.

(Technique 3) The heating device according to Technique 1 or 2, wherein the control unit determines a heating time for the high-output heating such that a heating amount in the high-output heating is a heating amount corresponding to the heating condition.

This makes it possible to perform the high-output heating to obtain a heating amount corresponding to the heating condition input by the user, and to perform the required heating in a shorter time.

(Technique 4) The heating device according to any of Techniques 1 to 3, wherein the control unit determines a heating time of the heating unit when performing the high-output heating, based on a heating amount to the object to be heated and an operation history of the heating unit.

This makes it possible to avoid an excessive load or the like on the heating unit and perform the high-output heating, and to heat the object to be heated appropriately in a shorter time.

(Technique 5) The heating device according to any of Techniques 1 to 4, wherein the control unit acquires an output possible time for which the heating unit can output microwaves at a higher output than the heating condition, and the control unit determines a heating time and an output of the heating unit in the high-output heating such that a time for which the heating unit is operated at an output higher than the heating condition does not exceed the output possible time and such that a heating amount in the high-output heating is a heating amount corresponding to the heating condition.

This makes it possible to perform the high-output heating not so as to exceed the time limit for operating the heating unit, and to heat the object to be heated appropriately in a shorter time.

(Technique 6) A heating device that heats an object to be heated with a heating unit, the device including: a heating unit capable of outputting microwaves at a plurality of different outputs; a manipulation unit that receives input of a heating condition including a heating time and an output of the heating unit; and a control unit that operates the heating unit based on the heating condition, wherein the manipulation unit includes a high-output manipulation unit that provides an instruction for a high-output heating including operating the heating unit at an output higher than the heating condition, and the control unit acquires an output possible time for which the heating unit can output microwaves at a higher output than the heating condition, and the control unit determines a heating time and an output of the heating unit in the high-output heating such that a time for which the heating unit is operated at an output higher than the heating condition does not exceed the output possible time and such that a heating amount in the high-output heating is a heating amount corresponding to the heating condition.

This makes it possible, through a simple manipulation, to provide an instruction for an operation to heat the object to be heated at an output higher than the output specified by the user, and to perform heating so as not to exceed the time limit for operating the heating unit in this operation. This makes it possible to heat the object to be heated appropriately in a shorter time, and to improve the user's convenience regarding heating and cooking.

(Technique 7) The heating device according to Technique 5 or 6, wherein the control unit executes the high-output heating including a first period and a second period in a condition, the condition being that a heating time, for causing a heating amount in the high-output heating to be a heating amount corresponding to the heating condition, exceeds the output possible time, the first period being a period in which the heating unit is operated at an output higher than the heating condition, the second period being a period in which the heating unit is operated at an output included in the heating condition.

This makes it possible to use a plurality of outputs to perform the necessary heating in a shorter time.

(Technique 8) The heating device according to Technique 7, wherein the control unit determines lengths of the first period and the second period such that a sum of a heating amount in the first period and a heating amount in the second period is a heating amount corresponding to the heating condition.

This makes it possible to use a plurality of outputs to perform the necessary heating in a shorter time.

(Technique 9) The heating device according to any of Techniques 5 to 8, further including a notification unit, wherein the control unit causes the notification unit to notify that the high-output heating is possible when the output possible time is greater than or equal to a threshold value.

This makes it possible to inform the user that the high-output heating can be executed, and the user can manipulate the high-output manipulation unit in response to the information, thereby completing heating more easily and in a shorter time. This makes it possible to improve the user's convenience regarding heating and cooking.

(Technique 10) The heating device according to Technique 9, wherein the control unit causes the notification unit to notify that the high-output heating is possible when a heating time when the high-output heating is performed is shorter than the heating condition.

This allows the user manipulating the high-output manipulation unit in response to the notification to more reliably shorten the heating time.

(Technique 11) The heating device according to Technique 9 or 10, wherein the control unit causes the notification unit to notify that the high-output heating is possible after receiving a manipulation, from the manipulation unit, to provide an instruction for starting heating.

This notifies that the high-output heating can be executed after the heating condition input by the user is settled. This allows the user to manipulate the high-output manipulation unit in response to the notification, thereby more reliably shortening the heating time.

(Technique 12) The heating device according to Technique 10, wherein the control unit operates the heating unit in accordance with the heating condition when a state in which the high-output manipulation unit is not manipulated continues for a predetermined time or more after notifying that the high-output heating is possible.

According to this, when the user does not want to perform the high-output heating, heating is promptly executed based on the heating condition input by the user. This makes it possible to improve the user's convenience regarding heating and cooking.

(Technique 13) The heating device according to any of Techniques 5 to 12, further including: a memory that temporarily stores data; and a non-volatile storage unit that stores data in a non-volatile manner, wherein the control unit stores state data indicating an operation state of the heating unit in the memory, updates the state data in response to an operation of the heating unit, calculates the output possible time based on the state data, and stores the state data in the non-volatile storage unit when an operating state of the heating device is in a predetermined state, and then reads out the state data from the non-volatile storage unit and stores the data in the memory.

This makes it possible to store the state data regarding the state of the heating unit in the memory to facilitate update, and to store the state data in the non-volatile storage unit to prepare for the disappearance of the state data. This makes it possible to appropriately manage the state of the heating unit.

(Technique 14) A heating device including: a heating unit that is configured to be capable of outputting microwaves at a plurality of different outputs and heats an object to be heated; a manipulation unit that receives input of a heating condition including a heating time and an output of the heating unit; and a control unit that operates the heating unit based on the heating condition, the control unit executing a high-output heating including operating the heating unit at an output higher than the heating condition, wherein the control unit acquires an output possible time for which the heating unit can output microwaves at a higher output than the heating condition, and the control unit determines a heating time and an output of the heating unit in the high-output heating such that a time for which the heating unit is operated at an output higher than the heating condition does not exceed the output possible time and such that a heating amount in the high-output heating is a heating amount corresponding to the heating condition.

This makes it possible, through a simple manipulation, to provide an instruction for an operation to heat the object to be heated at an output higher than the output specified by the user, and to perform heating so as not to exceed the time limit for operating the heating unit in this operation. This makes it possible to heat the object to be heated appropriately in a shorter time, and to improve the user's convenience regarding heating and cooking.

(Technique 15) A heating device that heats an object to be heated with a heating unit, the device including: a heating unit capable of outputting microwaves at a plurality of different outputs; a manipulation unit that receives input of a heating condition including a heating time and an output of the heating unit; and a control unit that operates the heating unit based on the heating condition, wherein the control unit executes a high-output heating including operating the heating unit at an output higher than the heating condition.

This makes it possible, through a simple manipulation, to provide an instruction for an operation to heat the object to be heated at an output higher than the output specified by the user. This improves the user's convenience regarding heating and cooking.

(Technique 16) A control method for a heating device including a heating unit and a manipulation unit, the heating unit being capable of outputting microwaves at a plurality of different outputs, the manipulation unit receiving input of a heating condition, the heating condition including a heating time and an output of the heating unit, the method including: using a control unit that controls the heating unit to operate the heating unit based on the heating condition, and execute a high-output heating including operating the heating unit at a maximum output higher than the heating condition in response to a manipulation of a high-output manipulation unit included in the manipulation unit.

This makes it possible, through a simple manipulation, to provide an instruction for an operation to heat the object to be heated at an output higher than the output specified by the user. This improves the user's convenience regarding heating and cooking.

(Technique 17) A control method for a heating device including a heating unit and a manipulation unit, the heating unit being capable of outputting microwaves at a plurality of different outputs, the manipulation unit receiving input of a heating condition, the heating condition including a heating time and an output of the heating unit, the method including: using a control unit that controls the heating unit to operate the heating unit based on the heating condition, and execute a high-output heating including operating the heating unit at a maximum output higher than the heating condition in response to a manipulation of a high-output manipulation unit included in the manipulation unit, wherein the control unit acquires an output possible time for which the heating unit can output microwaves at a higher output than the heating condition, and the control unit determines a heating time and an output of the heating unit in the high-output heating such that a time for which the heating unit is operated at an output higher than the heating condition does not exceed the output possible time and such that a heating amount in the high-output heating is a heating amount corresponding to the heating condition.

This makes it possible, through a simple manipulation, to provide an instruction for an operation to heat the object to be heated at an output higher than the output specified by the user, and to perform heating so as not to exceed the time limit for operating the heating unit in this operation. This makes it possible to heat the object to be heated appropriately in a shorter time, and to improve the user's convenience regarding heating and cooking.

(Technique 18) A program causing a computer to function as a control unit, the computer controlling a heating device, the heating device including a heating unit and a manipulation unit, the heating unit being capable of outputting microwaves at a plurality of different outputs, the manipulation unit receiving input of a heating condition, the heating condition including a heating time and an output of the heating unit, the control unit operating the heating unit based on the heating condition, the control unit executing a high-output heating including operating the heating unit at a maximum output higher than the heating condition in response to a manipulation of a high-output manipulation unit included in the manipulation unit.

This makes it possible, through a simple manipulation, to provide an instruction for an operation to heat the object to be heated at an output higher than the output specified by the user. This improves the user's convenience regarding heating and cooking.

### INDUSTRIAL APPLICABILITY

As described above, the heating device, the control method for the heating device, and the program according to the present invention can be used for heating food.

### REFERENCE SIGNS LIST

1 heating device
2 cabinet
3 manipulation panel
3A manipulation unit
4 door
7 heating chamber
30 first manipulation unit
31 microwave heating instruction key
32 cancel key
33 start key
39 dial
40 second manipulation unit
41 short-time heating key (high-output manipulation unit)
51 numerical value display unit
52 unit display
53 start guide icon
54 short-time heating icon
60 heating unit
61 magnetron
62 drive board
63 cooling fan
70 sound output unit (notification unit)
100 control unit
110 processor
111 reception unit
113 heating control unit
120 memory
121 first counter (state data)
122 second counter (state data)
130 non-volatile storage unit
131 control program
132 setting data
133 count data (state data)

1. A heating device that heats an object to be heated with a heating unit, the device comprising:
a heating unit capable of outputting microwaves at a plurality of different outputs;
a manipulation unit that receives input of a heating condition including a heating time and an output of the heating unit; and
a control unit that operates the heating unit based on the heating condition, wherein
the manipulation unit includes a high-output manipulation unit that provides an instruction for a high-output heating including operating the heating unit at an output higher than the heating condition, and
the high-output manipulation unit receives an instruction for the high-output heating including operating the heating unit at a maximum output of the heating unit.

2. The heating device according to claim 1, wherein the control unit determines a heating time for the high-output heating such that a heating amount in the high-output heating is a heating amount corresponding to the heating condition.

3. The heating device according to claim 1, wherein the control unit determines a heating time of the heating unit when performing the high-output heating, based on a heating amount to the object to be heated and an operation history of the heating unit.

4. A heating device that heats an object to be heated with a heating unit, the device comprising:
a heating unit capable of outputting microwaves at a plurality of different outputs;
a manipulation unit that receives input of a heating condition including a heating time and an output of the heating unit; and
a control unit that operates the heating unit based on the heating condition, wherein
the manipulation unit includes a high-output manipulation unit that provides an instruction for a high-output heating including operating the heating unit at an output higher than the heating condition,
the control unit acquires an output possible time for which the heating unit can output microwaves at a higher output than the heating condition, and
the control unit determines a heating time and an output of the heating unit in the high-output heating such that a time for which the heating unit is operated at an output higher than the heating condition does not exceed the output possible time and such that a heating amount in the high-output heating is a heating amount corresponding to the heating condition.

5. The heating device according to claim 4, wherein the control unit executes the high-output heating including a first period and a second period in a condition, the condition being that a heating time, for causing a heating amount in the high-output heating to be a heating amount corresponding to the heating condition, exceeds the output possible time, the first period being a period in which the heating unit is operated at an output higher than the heating condition, the second period being a period in which the heating unit is operated at an output included in the heating condition.

6. The heating device according to claim 5, wherein the control unit determines lengths of the first period and the second period such that a sum of a heating amount in the first period and a heating amount in the second period is a heating amount corresponding to the heating condition.

7. The heating device according to claim 4, further comprising a notification unit,
wherein the control unit causes the notification unit to notify that the high-output heating is possible when the output possible time is greater than or equal to a threshold value.

8. The heating device according to claim 7, wherein the control unit causes the notification unit to notify that the high-output heating is possible when a heating time when the high-output heating is performed is shorter than the heating condition.

9. The heating device according to claim 7, wherein the control unit notifies that the high-output heating is possible after receiving a manipulation, from the manipulation unit, to provide an instruction for starting heating.

10. The heating device according to claim 9, wherein the control unit operates the heating unit in accordance with the heating condition when a state in which the high-output manipulation unit is not manipulated continues for a predetermined time or more after notifying that the high-output heating is possible.

11. The heating device according to claim 4, further comprising:
a memory that temporarily stores data; and
a non-volatile storage unit that stores data in a non-volatile manner, wherein
the control unit
stores state data indicating an operation state of the heating unit in the memory,
updates the state data in response to an operation of the heating unit,
calculates the output possible time based on the state data, and
stores the state data in the non-volatile storage unit when an operating state of the heating device is in a predetermined state, and then reads out the state data from the non-volatile storage unit and stores the data in the memory.

12. A heating device that heats an object to be heated with a heating unit, the device comprising:
a heating unit capable of outputting microwaves at a plurality of different outputs;
a manipulation unit that receives input of a heating condition including a heating time and an output of the heating unit; and
a control unit that operates the heating unit based on the heating condition,
wherein the control unit executes a high-output heating including operating the heating unit at a maximum output higher than the heating condition.

13. A heating device comprising:
a heating unit that is configured to be capable of outputting microwaves at a plurality of different outputs and heats an object to be heated;
a manipulation unit that receives input of a heating condition including a heating time and an output of the heating unit; and
a control unit that operates the heating unit based on the heating condition,
the control unit executing a high-output heating including operating the heating unit at an output higher than the heating condition, wherein
the control unit acquires an output possible time for which the heating unit can output microwaves at a higher output than the heating condition, and
the control unit determines a heating time and an output of the heating unit in the high-output heating such that a time for which the heating unit is operated at an output higher than the heating condition does not exceed the output possible time and such that a heating amount in the high-output heating is a heating amount corresponding to the heating condition.

14. A control method for a heating device including a heating unit and a manipulation unit, the heating unit being capable of outputting microwaves at a plurality of different outputs, the manipulation unit receiving input of a heating condition, the heating condition including a heating time and an output of the heating unit, the method comprising:
using a control unit that controls the heating unit to
operate the heating unit based on the heating condition, and
execute a high-output heating including operating the heating unit at a maximum output higher than the heating condition in response to a manipulation of a high-output manipulation unit included in the manipulation unit.

15. A control method for a heating device including a heating unit and a manipulation unit, the heating unit being capable of outputting microwaves at a plurality of different outputs, the manipulation unit receiving input of a heating condition, the heating condition including a heating time and an output of the heating unit, the method comprising:
using a control unit that controls the heating unit to
operate the heating unit based on the heating condition, and
execute a high-output heating including operating the heating unit at a maximum output higher than the heating condition in response to a manipulation of a high-output manipulation unit included in the manipulation unit, wherein
the control unit acquires an output possible time for which the heating unit can output microwaves at a higher output than the heating condition, and
the control unit determines a heating time and an output of the heating unit in the high-output heating such that a time for which the heating unit is operated at an output higher than the heating condition does not exceed the output possible time and such that a heating amount in the high-output heating is a heating amount corresponding to the heating condition.

16. A non-transitory computer-readable recording medium having stored thereon a program causing a computer to function as a control unit,
the computer controlling a heating device, the heating device including a heating unit and a manipulation unit, the heating unit being capable of outputting microwaves at a plurality of different outputs, the manipulation unit receiving input of a heating condition, the heating condition including a heating time and an output of the heating unit,
the control unit operating the heating unit based on the heating condition, the control unit executing a high-output heating including operating the heating unit at a maximum output higher than the heating condition in response to a manipulation of a high-output manipulation unit included in the manipulation unit.
